(19) United States
(12) Patent Application Publication
(10) Pub. No.: US 2008/0056117 A1
(43) Pub. Date: Mar. 6, 2008

(54) SPECIFICATION OF SUB-CHANNELS FOR FDM BASED TRANSMISSION INCLUDING OFDMA AND SC-OFDMA

(76) Inventors: Tarik Muharemovic, Dallas, TX (US); Vijay Sundararajan, Richardson, TX (US)

Correspondence Address: TEXAS INSTRUMENTS INCORPORATED, P O BOX 655474, M/S 3999, DALLAS, TX, 75265, US

(21) Appl. No.: 11/848,415

(22) Filed: Aug. 31, 2007

Related U.S. Application Data
(60) Provisional application No. 60/824,366, filed on Sep. 1, 2006.

(51) Int. Cl. H04J 11/00

(52) U.S. Cl. 370/203

(57) ABSTRACT

A method for defining a valid set of sub-channels {1, 2, . . . , K} for transmission between a user device and a base station, where each sub-channel “k” has sub-carrier spacing s[k]. Sub-carriers of each sub-channel are equi-spaced. That is, for each sub-channel “k”, the distance between consecutive sub-carriers is maintained at a fixed level s[k]. Different sub-channels can have different sub-carrier spacing s[k]. Sub-channels are non-overlapping. A resource tree is used to select a valid set of sub-channels from a set of possible tone spacing's that include sequence {M₁, M₂, . . . , M_{N}} of not necessarily different positive integers.

### CLAIM OF PRIORITY

This application for Patent claims priority to U.S. Provisional Application No. 60/824,366 entitled “Specification of Sub-Channels for FDM Based Transmission Including OFDMA and SC-OFDMA” filed Sep. 1, 2006, incorporated by reference herein.

### FIELD OF THE INVENTION

Embodiments of this invention generally relate to wireless communication, and in particular to selection of sub-channels for single carrier orthogonal frequency division multiple access (SC-FDMA) systems.

### BACKGROUND OF THE INVENTION

The Global System for Mobile Communications (GSM: originally from Groupe Special Mobile) is currently the most popular standard for mobile phones in the world and is referred to as a 2G (second generation) system. Universal Mobile Telecommunications System (UMTS) is one of the third-generation (3G) mobile phone technologies. Currently, the most common form uses W-CDMA (Wideband Code Division Multiple Access) as the underlying air interface. W-CDMA is the higher speed transmission protocol designed as a replacement for the aging 2G GSM networks deployed worldwide. More technically, W-CDMA is a wideband spread-spectrum mobile air interface that utilizes the direct sequence Code Division Multiple Access signaling method (or CDMA) to achieve higher speeds and support more users compared to the older TDMA (Time Division Multiple Access) signaling method of GSM networks.

Orthogonal Frequency Division Multiple Access (OFDMA) is a multi-user version of the popular Orthogonal Frequency-Division Multiplexing (OFDM) digital modulation scheme. Multiple access is achieved in OFDMA by assigning subsets of sub-carriers to individual users. This allows simultaneous low data rate transmission from several users. Based on feedback information about the channel conditions, adaptive user-to-sub-carrier assignment can be achieved. If the assignment is done sufficiently fast, this further improves the OFDM robustness to fast fading and narrow-band co-channel interference, and makes it possible to achieve even better system spectral efficiency. Different number of sub-carriers can be assigned to different users, in view to support differentiated Quality of Service (QoS), i.e. to control the data rate and error probability individually for each user. OFDMA is used in the mobility mode of IEEE 802.16 WirelessMAN Air Interface standard, commonly referred to as WiMAX. OFDMA is currently a working assumption in 3GPP Long Term Evolution (LTE) downlink. Also, OFDMA is the candidate access method for the IEEE 802.22 “Wireless Regional Area Networks”.

NodeB is a term used in UMTS to denote the BTS (base transceiver station). In contrast with GSM base stations, NodeB uses WCDMA or OFDMA as air transport technology, depending on the type of network. As in all cellular systems, such as UMTS and GSM, NodeB contains radio frequency transmitter(s) and the receiver(s) used to communicate directly with the mobiles, which move freely around it. In this type of cellular networks the mobiles cannot communicate directly with each other but have to communicate with the BTSs

Traditionally, the NodeBs have minimum functionality, and are controlled by an RNC (Radio Network Controller). However, this is changing with the emergence of High Speed Downlink Packet Access (HSDPA), where some logic (e.g. retransmission) is handled on the NodeB for lower response times and in 3GPP LTE (a.k.a. E-UTRA) almost all the RNC functionalities have moved to the NodeB.

The utilization of cellular technologies allows cells belonging to the same or different NodeBs and even controlled by different RNC to overlap and still use the same frequency. The effect is utilized in soft handovers.

Since WCDMA and OFDMA often operates at higher frequencies than GSM, the cell range is considerably smaller compared to GSM cells, and, unlike in GSM, the cells' size is not constant (a phenomenon known as “cell breathing”). This requires a larger number of NodeBs and careful planning in 3G (UMTS) networks. Power requirements on NodeBs and UE (user equipment) are much lower.

A NodeB can serve several cells, also called sectors, depending on the configuration and type of antenna. Common configuration include omni cell (360°), 3 sectors (3×120°) or 6 sectors (3 sectors 120° wide overlapping with 3 sectors of different frequency).

High-Speed Packet Access (HSPA) is a collection of mobile telephony protocols that extend and improve the performance of existing UMTS protocols. Two standards HSDPA and HSUPA have been established. High Speed Uplink Packet Access (HSUPA) is a packet-based data service of Universal Mobile Telecommunication Services (UMTS) with typical data transmission capacity of a few megabits per second, thus enabling the use of symmetric high-speed data services, such as video conferencing, between user equipment and a network infrastructure.

An uplink data transfer mechanism in the HSUPA is provided by physical HSUPA channels, such as an Enhanced Dedicated Physical Data Channel (E-DPDCH), implemented on top of the uplink physical data channels such as a Dedicated Physical Control Channel (DPCCH) and a Dedicated Physical Data Channel (DPDCH), thus sharing radio resources, such as power resources, with the uplink physical data channels. The sharing of the radio resources results in inflexibility in radio resource allocation to the physical HSUPA channels and the physical data channels.

The signals from different users within the same cell may interfere with one another. This type of interference is known as the intra-cell interference. In addition, the base station also receives the interference from the users transmitting in neighboring cells. This is known as the inter-cell interference

When an orthogonal multiple access scheme such as Single-Carrier Frequency Division Multiple Access (SC-FDMA)—which includes interleaved and localized Frequency Division Multiple Access (FDMA) or Orthogonal Frequency Division Multiple Access (OFDMA)—is used; intra-cell multi-user interference is not present. This is the case for the next generation UMTS enhanced-UTRA (E-UTRA) system—which employs SC-FDMA—as well as IEEE 802.16e also known as Worldwide Interoperability for Microwave Access (WiMAX)—which employs OFDMA, In this case, the fluctuation in the total interference only comes from inter-cell interference and thermal noise which tends to be slower. While fast power control can be utilized, it can be argued that its advantage is minimal.

In the uplink (UL) of OFDMA frequency division multiple access (both classic OFDMA and SC-FDMA) communication systems, it is beneficial to provide orthogonal reference signals (RS), also known as pilot signals, to enable accurate channel estimation and channel quality indicator (CQI) estimation enabling UL channel dependent scheduling, and to enable possible additional features which require channel sounding.

Channel dependent scheduling is widely known to improve throughput and spectral efficiency in a network by having the Node B, also referred to as base station, assign an appropriate modulation and coding scheme for communications from and to a user equipment (UE), also referred to as mobile, depending on channel conditions such as the received signal-to-interference and noise ratio (SINR). In addition to channel dependent time domain scheduling, channel dependent frequency domain scheduling has been shown to provide substantial gains over purely distributed or randomly localized (frequency hopped) scheduling in OFDMA-based systems. To enable channel dependent scheduling, a corresponding CQI measurement should be provided over the bandwidth of interest. This CQI measurement may also be used for link adaptation, interference co-ordination, handover, etc.

One method for forming reference signals is described in US patent application 20070171995, filed Jul. 26, 2007 and entitled “Method and Apparatus for Increasing the Number of Orthogonal Signals Using Block Spreading” and is incorporated by reference herein. The generation of reference signals (RS) sequences can be based on the constant amplitude zero cyclic auto-correlation (CAZAC) sequences, and the use of block spreading for multiplexing RS from multiple UE transmitters is described therein.

### SUMMARY OF THE INVENTION

An embodiment of the present invention provides a method for defining a valid set of sub-channels {1, 2, . . . , K} for transmission between a user device and a base station, where each sub-channel “k” has sub-carrier spacing s[k]. Sub-carriers of each sub-channel are equi-spaced. That is, for each sub-channel “k”, the distance between consecutive sub-carriers is maintained at a fixed level s[k]. Different sub-channels can have different sub-carrier spacing s[k]. Sub-channels are non-overlapping. A resource tree is used to select a valid set of sub-channels from a set of possible tone spacing's that include sequence {M₁, M₂ , . . . M_{N}} of not necessarily different positive integers.

### BRIEF DESCRIPTION OF THE DRAWINGS

Particular embodiments in accordance with the invention will now be described, by way of example only, and with reference to the accompanying drawings:

FIG. 1 is a representation of two cells in a cellular communication network that includes an embodiment of a valid sub-channel specification;

FIG. 2 is a block diagram of an SC-OFDMA system for transmitting specified sub-frame structures;

FIG. 3A is an example of a trivial specification of sub-channels;

FIG. 3B is an example of a non-trivial specification of sub-channels;

FIG. 4 is an illustration of a recursive relationship which defines a resource tree;

FIG. 5 is an illustration of the resource tree defined be the recursive relationship of FIG. 4;

FIG. 6 is an example of an enumerated resource tree of FIG. 5;

FIG. 7 is an example of a valid specification of sub-channels formed on the resource tree of FIG. 6;

FIG. 8A is an illustration of valid specification of sub-channels applied to multiple signal multiplexing blocks (SMB);

FIG. 8B is an illustration of partitioning of sub-channels from a valid specification of sub-channels to form sub-sub-channels;

FIG. 9 is a flow chart illustrating selection of a valid specification of sub-channels; and

FIG. 10 is a block diagram illustrating a mobile device that uses sub-channel specification.

### DETAILED DESCRIPTION OF EMBODIMENTS OF THE INVENTION

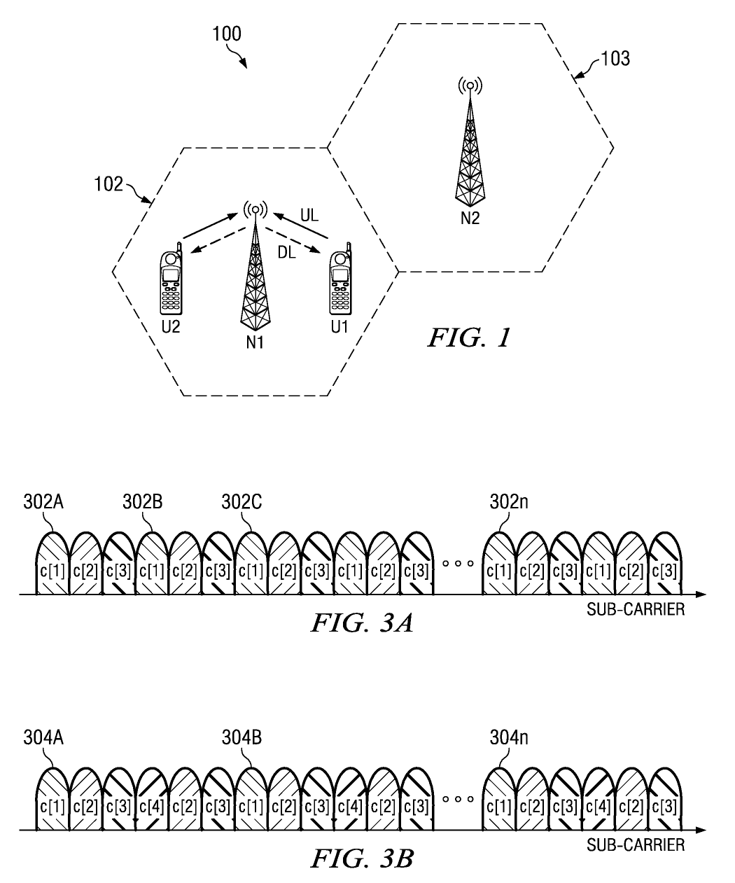

FIG. 1 is a representation of two cells in a cellular communication network 100 that includes an embodiment of multiplexed transmission with different tone spacing.. In this representation only two cells 102-103 are illustrated for simplicity, but it should be understood that the network includes a large matrix of cells and each cell is generally completely surrounded by neighboring cells. A representative set of user equipment U1-U2 is currently in cell 102 and is being served by NodeB N1. Cell 103 is a neighbor cell and NodeB N2 is not serving UE U1-U2. U1 and U2 are representative of a set of user equipment in any given cell since there will typically be tens or hundreds of UE in each cell. Each UE communicates with its serving NodeB using an uplink transmission UL and a downlink transmission DL.

Embodiments of this invention apply to all FDM based transmissions which utilize the concept of tones or sub-carriers. The following terminology definitions will be used throughout this description. A sub-channel is defined as any collection of one or more sub-carriers (or tones). In this document, the term “tones” and “sub-carriers” will be used interchangeably. An equi-spaced sub-channel “k” is a sub-channel “k” whose consecutive sub-carriers have a fixed spacing; this fixed sub-carrier spacing will henceforth be denoted as s[k]. “Spacing” between sub-carriers equals the difference between their indexes; for example, spacing between sub-carrier 4 and sub-carrier 1 is 3 (not 2).

FIG. 2 is a block diagram of an SC-OFDMA system for transmitting specified sub-frame structures, as will be described in more detail below. The information bits, after passing through the coding block 302, including an encoder, a CRC attachment and an interleaver, are provided to the modulating unit of the SC-FDMA system. After applying a Discrete Fourier Transform (DFT) 308 on the data, which may also be an ACK/NAK or a CQI related to the downlink (DL) communication, mapping 310 of the DFT output is performed on a selected part of the operating bandwidth (BW). This mapping may be localized, implying that the data sub-carriers occupy a continuous part of the BW, or distributed, implying that the data sub-carriers occupy a discontinuous part of the BW. Subsequently, an Inverse Fast Fourier Transform (IFFT) 312 operation is applied, followed by a cyclic prefix (CP) insertion 314, time windowing 316 to produce a signal with the desired spectral characteristics, a digital-to-analog converter (DAC) 318, and finally the transmission (Tx) radio frequency (RF) circuitry 320 which includes a power amplifier and the transmitter antenna. In addition the UE may be responsive to Node B signaling indicating a transmit time and/or transmit power adjustment. Similar processing can be applied for the reference signal (RS) which is a non-modulated signal (carries no information) in order to allow the Node B to perform channel related estimation functions.

Mapping unit 310 produces localized and distributed transmissions in the frequency domain. Control module 311 is responsive to scheduling commands received on the downlink from the serving NodeB and configures mapping unit 310 in response to the received commands. More specifically, the scheduling operation refers to localized signal transmission in contiguous parts of bandwidth (BW), referred to as resource blocks (RBs). In the some embodiments, the RBs assigned to a UE are consecutive, but in general they may be anywhere in the overall scheduling BW. The scheduling BW during a given time period is typically only a part of the total operating BW.

Typically, different data streams will be transmitted on different sub-channels, be it in the uplink or in the downlink of a wireless or wire-line communication system. Due to a number of different reasons, it may be desirable to define sub-channels with following two restrictions: 1) Sub-carriers of each sub-channel must be equi-spaced. That is, for each sub-channel “k”, the distance between consecutive sub-carriers is maintained at a fixed level s[k]. Clearly, different sub-channels can have different sub-carrier spacing s[k]; 2) Sub-channels must be non-overlapping.

Restriction 2 is typically imposed because of orthogonality requirements for different data streams. Restriction 1 may be imposed for simplicity of sub-channel definition. For example, a sub-channel can be defined and signaled (for instance in downlink) by defining the first used sub-carrier, sub-carrier spacing, and the number of used sub-carriers. Alternatively, Restriction 2 may be simply required due to alternate physical layer considerations. For example, in SC-OFDM(A) transmission, the set of used sub-carriers simply has to be equi-spaced. An exemplary diagram for SC-OFDM(A) transmission is given in FIG. 3A. Nevertheless, embodiments of the invention which is described herein applies to all FDM-based multiplexing strategies which include, but are not limited to: OFDMA, OFDM, SC-OFDMA, SC-OFDM, DFT-spread OFDMA, DFT-spread OFDM, and MC-CDMA.

Clearly, when each of the sub-channels uses the same common tone spacing, then the problem of sub-channel specification is trivial. For example, FIG. 3A shows a trivial definition of three sub-channels c[1], c[2], c[3] where tone spacing for each sub-channel is three. As can be seen in the illustration, tones 302A, 302B, 302C, 302n have a same spacing of three. The problem of a valid sub-channel specification arises when different sub-channels must use different tone spacing. A simple example of this is given in FIG. 3B. In this case, sub-channels c[1] and c[4] have a sub-carrier spacing of six as illustrated by 304A, 304b, 304n while channels c[2] and c[3] have a sub-carrier spacing of three.

Embodiments of this invention define sub-channels which have different sub-carrier spacing, while simultaneously satisfying Restriction 1 and Restriction 2 from the above. For instance, sub-channel “k” must have a sub-carrier spacing of s[k]. Such a scenario can often arise because different sub-channels can carry different data streams, which have different data rates and some sub-channels may require more bandwidth. Such a scenario can also arise in cases where different data streams, for example, from different mobiles, are to use different densities of the reference signal due to different delay spreads.

In order to multiplex without overlapping two different sub-channels, each of which is equi-spaced, the sub-carrier spacing of one sub-channel must be an integral multiple of the sub-carrier spacing of another sub-channel. For example, it is impossible to multiplex spacing of s[1]=2 and s[2]=3, while it is feasible to multiplex spacing of s[1]=2 and s[2]=4. Thus, in order to define, or select, a valid set of sub-channels, it is useful to define a set of possible tone spacing's.

Definition: Let {M₁, M₂, . . . , M_{N}} be any sequence of not necessarily different positive integers. Then, the set of possible tone spacing's is defined as follows

$$Λ = \{ {M}_{1} , {M}_{1} {M}_{2} , {M}_{1} {M}_{2} {M}_{3} , … , {\prod }_{n = 1}^{N} {M}_{n} \} \qquad ( 1 )$$

If any two tone spacing's are selected from this set Λ, one spacing will be an integral multiple of another, or alternatively, two spacing's will be the same.

A feasibility condition for multiplexing transmissions with different tone spacing's can be stated as follows. Without loss of generality, let s[1]≦s[2]≦ . . . ≦s[K] be the set of desired tone (sub-carrier) spacing's, where k-th spacing s[k] is to be applied to the k-th sub-channel. Then, the non-overlapping solution for the K sub-channels exists if and only if s[k] belongs to some set Λ, for some values of M₁,M₂, . . . , M_{N}, and for every k from {1, 2, . . . , K}, and simultaneously

$${\sum }_{k = 1}^{K} \frac{1}{s [ k ]} \leq 1 \qquad ( 2 )$$

This mathematical fact (feasibility condition) can be proven using principles of discrete math; furthermore, this feasibility condition is assumed to be satisfied (possibly validated) before proceeding with all subsequently described designs. Thus, this design mandates the set of “possible tone spacing's” to be A, with the structure as defined above. Given this particular set Λ, it can be noted that for any pair of tone spacing's, one spacing is an integral multiple of another. Furthermore, the collection s[1], s[2], . . . , s[K] is the collection of “used tone spacing's,” where each s[k] belongs to the set Λ of “possible tone spacing's.” When and only when the strict equality holds in the above relation, then all sub-carriers are fully utilized. One example where four sub-channels are simultaneously defined and multiplexed is given in FIG. 3B, with s[1]=3 for c[1], s[2]=3 for c[2], s[3]=6 for c[3], and s[4]=6 for c[4].

In order to provide a design for multiplexing transmissions with possibly different tone spacing's, the concept of a “resource tree” is useful. The root vertex of the resource tree will be labeled as v[0, 1] and the root vertex will have M₁ children, which descend from the root vertex. Children of the root vertex will be labeled as v[0, M₁], v[1, M₁], . . . , v[M₁−1, M₁]. Each of these children (of the root vertex) will have M₂ children of their own, each of which will have M₃ children of their own, etc until the last sub-level M_{N}. In general, a resource tree is defined as follows:

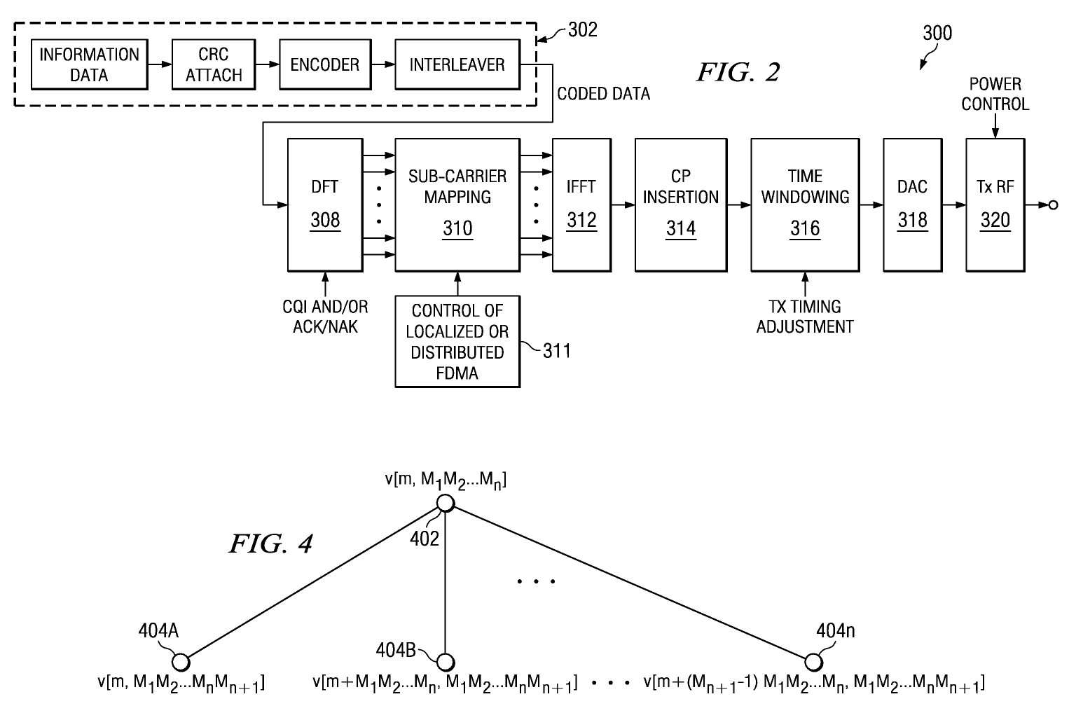

Definition: The resource tree is defined recursively, starting from the root vertex v[0, 1], which has no parent node. The root vertex v[0, 1] has M₁ children: v[0, M₁], v[1, M₁], . . . , v[M₁−1, M₁]. A recursive relationship for generating the remaining vertices of the resource tree is: any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}. This recursive relationship, which fully defines the resource tree, is shown in FIG. 4. Vertex 402 is the root vertex for this recursion. Child vertices 404A, 404B, 404n represent child vertices of the root vertex 402. Each child vertex then becomes a root vertex in the next recursion until sub-level M_{N} is reached.

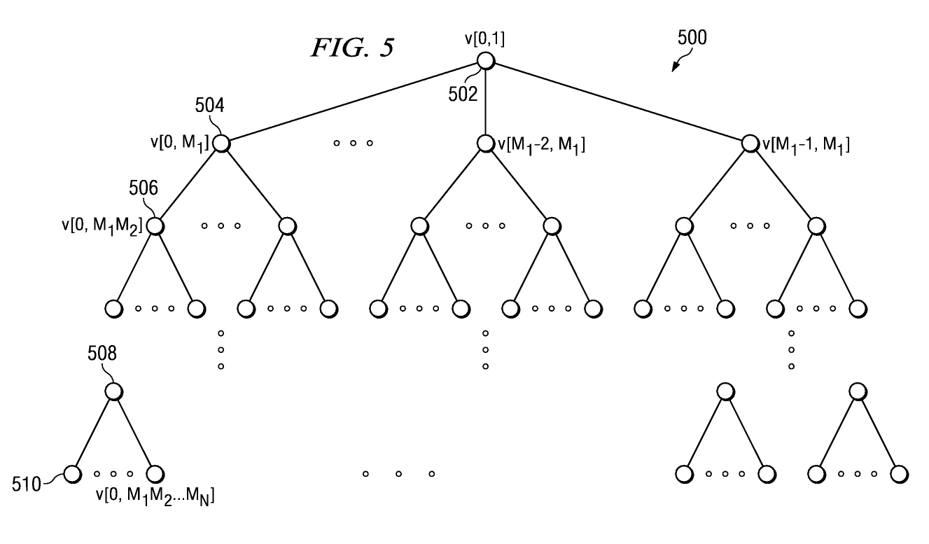

FIG. 5 is an illustration of a resource tree 500 defined be the recursive relationship of FIG. 4. Vertex 502 is the root vertex of resource tree 500. Vertex 504 is the first child at sub-level one. Vertex 506 is the first child at sub-level two. Vertex 508 is the first child at sub-level N−1 and vertex 510 is the first child at sub-level N.

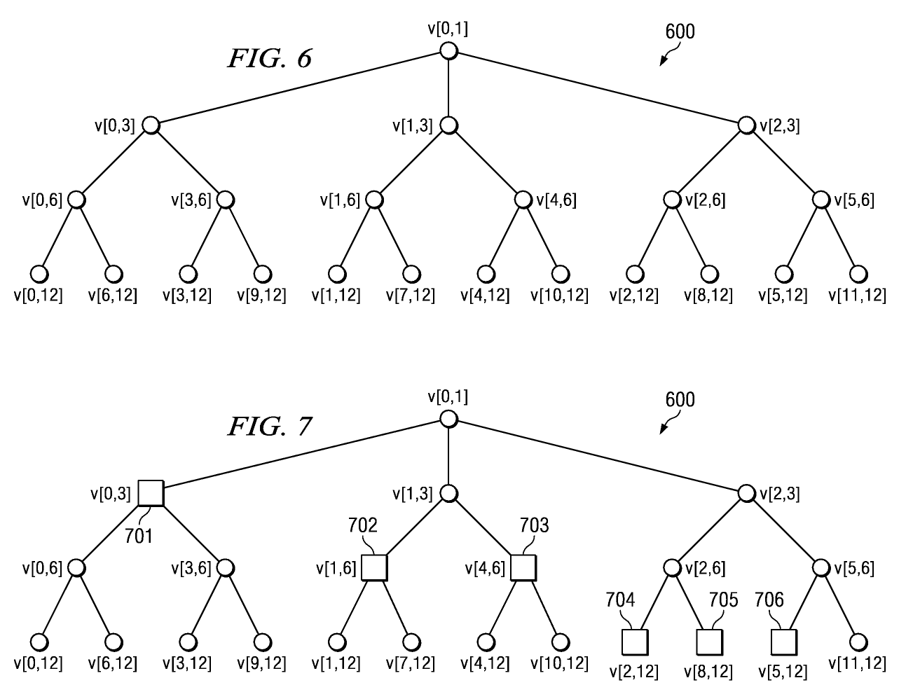

FIG. 6 is an example of an enumerated resource tree 600 that illustrates mapping of the possible sub-channel spacing's onto the resource tree vertices. In this example, the sequence of not necessarily different positive integers is: {3, 2, 2}.

Vertices of the resource tree are interpreted as follows: each vertex v[m, M₁M₂ . . . Mₙ] represents a potential sub-channel which is defined by the tone spacing M₁M₂ . . . Mₙ and by the relative offset “m,” with respect to some frame of reference. The offset could be a fixed sub-carrier, for example. Note that each child vertex, which is labeled as v[m+qM₁M₂. . . Mₙ, M₁M₂ . . . MₙMₙ₊₁], for some q, only occupies a subset of sub-carriers from its parent vertex v[m, M₁M₂ . . . Mₙ]. Thus, if a particular vertex v[m, M₁M₂ . . . Mₙ] is actually used in the final allocation of sub-channels, then no descendants (children, grand-children, . . . ) of that vertex (vertex v[m, M₁M₂ . . . Mₙ]) are allowed to be used, in the final allocation of sub-channels.

A “Valid Specification of Sub-Channels” is any set X of vertices on the resource tree, so that no vertex from X descends from another vertex from X. Each vertex v[m, M₁M₂ . . . Mₙ] from X, represents a sub-channel which uses sub-carrier spacing M₁M₂ . . . Mₙ with a relative offset “m.”

Any Valid Specification of Sub-Channels X solves the problem of multiplexing different UEs with different tone spacing's. Thus, when each sub-channel from X is allocated to a different UE, then two desired goals are satisfied: first, each UE transmitter uses equi-spaced tones, and second, tones used by different UEs are non-overlapping. An example of Valid Specification of Sub-Channels (for M₁=3, M₂=2, M₃=2) is given in FIG. 7. In this example, vertices 701-706 are selected, corresponding to tone spacing's of 3 with offset of 0, 6 with offset of 1, 6 with offset of 4, 12 with offset of 2, 12 with offset of 8, and 12 with offset of 5 respectively.

Thus, specifying particular sub-channel, with equi-spaced sub-carriers, amounts to specifying a vertex from the resource tree. A valid specification of sub-channels is nothing more than a set of vertices, with the above stated properties. A greedy algorithm which is guaranteed to converge for a valid specification of sub-channels starts from s[1]≦s[2]≦ . . . ≦s[K], can be assumed without loss of generality with the appropriate ordering permutation. Table 1 presents an example of pseudo—code for a greedy algorithm.

TABLE 1
Pseudo-code for a greedy algorithm

```
Initialization: all vertices are available
for k = 1 to K do
      find an available vertex v[m, s[k]] from the list of available
      vertices
put v[m, s[k]] into X
remove v[m, s[k]] and all its descendents from the list of available
vertices.
end
```

During each pass (value of “k”), the above greedy algorithm for selecting a valid specification of sub-channels involves a selection, which is left up to implementer, for finding an available vertex v[m, s[k]], from the list of available vertices. This algorithm is just a mere example for finding a valid specification of sub-channels, and other algorithms are clearly possible. Thus, embodiments of this invention are not limited to a particular valid specification of sub-channels but instead encompass a wide variety of valid specifications.

Using basic combinatorial principles, it can be shown that the number of different available choices for a valid specification of sub-channels is given as follows

$$L = {\prod }_{k = 1}^{K} [ s [ k ] + 1 - {\sum }_{n = 1}^{k} \frac{s [ k ]}{s [ n ]} ] \qquad ( 3 )$$

First term in above product is s[1], second term is s[2]-s[2]/s[1], third term is s[3]-s[3]/s[1]-s[3]/s[2] etc. This formula is one generalization of the factorial formula, because if all s[k] are equal, which is the case in the trivial specification of sub-channels, then the number of different available choices for the Valid Specification of Sub-Channels becomes factorial(s[k]). Still, above formula for L is much more general. The set of possible choices for valid specification of channels can be used to define frequency hopping solutions, as is described next.

Frequency hopping is typically desired in frequency division multiplex-based systems because it creates a number of beneficial effects, such as out-of-cell interference averaging. When frequency hopping is applied, the final choice for X changes over time. For example, hopping could be performed for each symbol, for each sub-frame, or for any other time unit. Thus, frequency hopping patterns for each sub-channel have to be designed jointly, and, at any given time, the used X must be a valid specification of sub-channels as defined above. Here, it is noted that for any desired set of s[1]≦s[2]≦ . . . ≦s[K], there are a total of L possibilities for the valid specification of sub-channels, so the maximum frequency hopping period is L. Nevertheless, other smaller periods are not precluded. Besides frequency hopping, other interference management strategies can also be combined with the above described allocation, such as for example, fractional frequency reuse.

### Generalizations

In case of virtual multiple-input, multiple-output MIMO data channel transmissions, more than one UE can use any particular sub-channel v[m, M₁M₂ . . . Mₙ]. Thus, the case of “virtual MIMO” doesn't affect the Valid Specification of Sub-Channels, and the proposed sub-channel design can still be readily applied, even if a particular sub-channel is used by more than one mobile.

In many cases, it is not desired that one equi-spaced sub-channel spans across the whole bandwidth, but rather, only a portion of the bandwidth. In such cases, there are several design options, as follows.

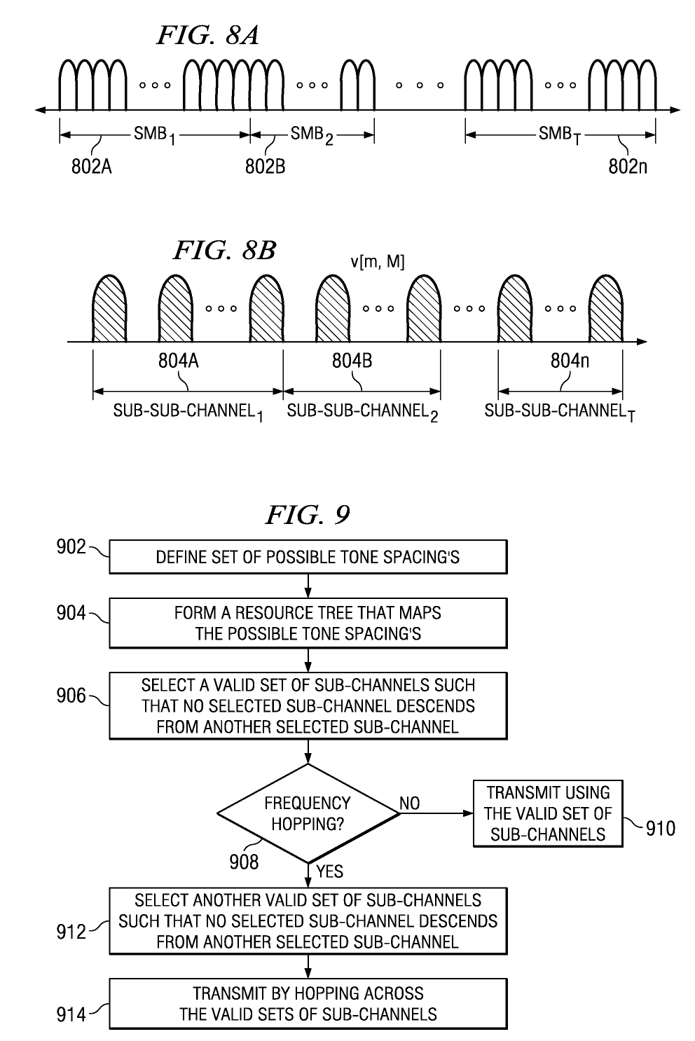

Option1: As illustrated in FIG. 8A, in this option, the entire system bandwidth is divided into signal multiplexing blocks (SMBs) 802A-802n, where each SMB occupies a contiguous set of tones (sub-carriers). SMBs need not be of the same size. Then, the above described design for valid specification of sub-channels can be applied to each SMB individually.

Option2: As illustrated in FIG. 8B, in this option, the valid specification of sub-channels is performed first. Then, each sub-channel v[m, M] is partitioned into a number of different sub-sub-channels 804A-804n, each of which contains tones which are in a pre-defined range. Sub-sub-channels need not be of the same size.

Option3: A hybrid design of Option1 and Option2 is also possible.

### Applications:

Application 1: Multiplexing UEs with Different Bandwidth Requirements: One clear application of the described methodology is for the scenario where a number of different mobiles transmit data in the uplink, each with an equi-spaced set of sub-carriers, but with different tone spacing's. Such is the scenario where some mobiles are given more bandwidth than the other, and the above described design for a valid specification of sub-channels directly applies to this scenario.

Application2: Adapting Spacing of an FDM Reference Signal to Mobile's Delay Spreads: In this application, the reference (pilot) signal for each mobile is designed in accordance to its (the mobile's) delay spread. Timing uncertainty is also included in the delay spread. Thus, the reference signal from different mobiles is FDM multiplexed with different s[k], which are adjusted in accordance to each user device's delay spread. An example of such a design proceeds as follows. Based on the sampling theorem, if time duration of the reference signal is E (common for all mobiles), and the delay spread of the mobile k is F[k] (assume that F[K]≧ . . . ≧F[2]≧F[1]), then sub-carrier spacing for this mobile should not exceed E/F[k]. This means that s[k]≦E/F[k]. Thus, s[k] is selected to be the largest element of A which satisfies the sampling condition s[k]≦E/F[k]. This is performed for each s[k] individually, and the reference signal design proceeds using a valid specification of sub-channels as previously described. Naturally, this design requires delay spreads of mobiles to be measured and may require additional dedicated signaling. This design can be applied for both uplink and the downlink reference signal design.

FIG. 9 is a flow chart illustrating selection of a valid specification of sub-channels {1, 2, . . . , K} for transmission between a user device and a base station, where each sub-channel “k” has sub-carrier spacing s[k].

A set of possible tone spacing's is defined 902 that is a sequence

$$Λ = \{ {M}_{1} , {M}_{1} {M}_{2} , {M}_{1} {M}_{2} {M}_{3} , … , {\prod }_{n = 1}^{N} {M}_{n} \} ,$$

where {M₁, M₂, . . . , M_{N}} is a sequence of not necessarily different positive integers.

In certain embodiments, a delay spread of transmissions received at the base station from the user device is estimated. The set of possible tone spacing's for the user device reference signal is then limited such that a maximum tone spacing is less than or equal to a time duration of a reference signal from the user device divided by the estimated delay spread of transmissions received at the base station from the user device.

A resource tree is formed 904 that has a root vertex with N sub-levels of vertices, wherein each vertex represents a potential sub-channel which is defined by the Mₙ tone spacing's and by a relative offset “m,” with respect to a frame of reference, such that any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}. The resource tree represents a mapping of all of the possible sub-channel spacing's and each vertex represents one particular sub-channel spacing.

A first valid set of sub-channels {1, 2, . . . , K} is selected 906 such that each of them can be mapped onto a vertex of the resource tree such that no selected sub-channel descends from another selected sub-channel. The selection meets the criteria for a valid set of sub-channels selected from the set of possible tone spacing's such that

$${\sum }_{k = 1}^{K} \frac{1}{s [ k ]} \leq 1.$$

Since this valid set of sub-channels is intended for non-equal spacing's, at least two s[k] will have different integer values

If frequency hopping is not being done 908, then transmission proceeds 910 using this set of valid sub-channels.

If frequency hopping is to be performed 908, then one or more additional sets of valid sub-channels are selected 912 using the same resource tree and selecting sub-channels each of which can be mapped onto a vertex of the resource tree such that no selected sub-channel descends from another previously selected sub-channel. Transmission then proceeds 914 by hopping across the multiple sets of valid sub-channels.

Referring again to FIG. 1, NodeB N1 performs the operations described above to form a reference tree and selects a valid set of sub-channels for use by UEs within cell 102. A representative NodeB contains one or more processing chips and memory resources that contain instruction code modules that direct the processing chip to perform processes 902, 904, 906, 908, and 912. NodeB N1 then sends a command to each UE U1, U2 directing each UE to transmit 910, 914 using a particular sub-channel selected from the set of valid sub-channels.

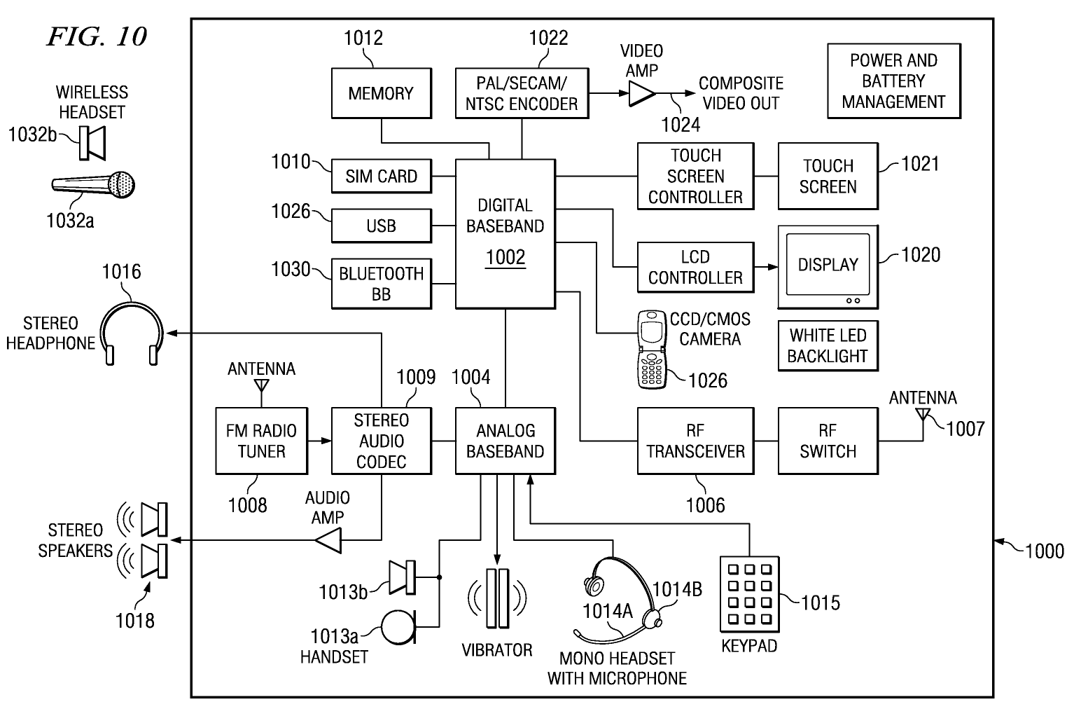

FIG. 10 is a block diagram of a UE 1000 that uses an embodiment of valid specification of sub-channels for transmissions, as described above. Digital system 1000 is a representative cell phone that is used by a mobile user. Digital baseband (DBB) unit 1002 is a digital processing processor system that includes embedded memory and security features. In this embodiment, DBB 1002 is an open media access platform (OMAPTM) available from Texas Instruments designed for multimedia applications. Some of the processors in the OMAP family contain a dual-core architecture consisting of both a general-purpose host ARMTM (advanced RISC (reduced instruction set processor) machine) processor and one or more DSP (digital signal processor). The digital signal processor featured is commonly one or another variant of the Texas Instruments TMS320 series of DSPs. The ARM architecture is a 32-bit RISC processor architecture that is widely used in a number of embedded designs.

Analog baseband (ABB) unit 1004 performs processing on audio data received from stereo audio codec (coder/decoder) 1009. Audio codec 1009 receives an audio stream from FM Radio tuner 1008 and sends an audio stream to stereo headset 1016 and/or stereo speakers 1018. In other embodiments, there may be other sources of an audio stream, such a compact disc (CD) player, a solid state memory module, etc. ABB 1004 receives a voice data stream from handset microphone 1013a and sends a voice data stream to handset mono speaker 1013b. ABB 1004 also receives a voice data stream from microphone 1014a and sends a voice data stream to mono headset 1014b. Usually, ABB and DBB are separate ICs. In most embodiments, ABB does not embed a programmable processor core, but performs processing based on configuration of audio paths, filters, gains, etc being setup by software running on the DBB. In an alternate embodiment, ABB processing is performed on the same OMAP processor that performs DBB processing. In another embodiment, a separate DSP or other type of processor performs ABB processing.

RF transceiver 1006 includes a receiver for receiving a stream of coded data frames from a cellular base station via antenna 1007 and a transmitter for transmitting a stream of coded data frames to the cellular base station via antenna 1007. A reference signal is transmitted to nearby base stations and configuration commands are received from the serving base station. Among the configuration commands will be a command to use a particular sub-channel for transmission that has been selected from a valid set of sub-channels by the serving NodeB. The NodeB defines a valid set of sub-channels as described above. Transmission of the scheduled resource blocks are performed by the transceiver using the sub-channel designated by the serving NodeB. Frequency hopping may be implied be using two or more sub-channels as commanded by the serving NodeB. In this embodiment, a single transceiver supports SC-FDMA operation but other embodiments may use multiple transceivers for different transmission standards. Other embodiments may have transceivers for a later developed transmission standard with appropriate configuration. RF transceiver 1006 is connected to DBB 1002 which provides processing of the frames of encoded data being received and transmitted by cell phone 1000.

The basic SC-FDMA DSP radio includes DFT, subcarrier mapping, and IFFT to form a data stream for transmission and DFT, subcarrier de-mapping and IFFT to recover a data stream from a received signal. DFT, IFFT and subcarrier mapping/de-mapping may be performed by instructions stored in memory 1012 and executed by DBB 1002 in response to signals received by transceiver 1006. The sub-carrier(s) that is(are) used for transmission are selected from a valid set of sub-carriers that is defined as described above.

DBB unit 1002 may send or receive data to various devices connected to USB (universal serial bus) port 1026. DBB 1002 is connected to SIM (subscriber identity module) card 1010 and stores and retrieves information used for making calls via the cellular system. DBB 1002 is also connected to memory 1012 that augments the onboard memory and is used for various processing needs. DBB 1002 is connected to Bluetooth baseband unit 1030 for wireless connection to a microphone 1032a and headset 1032b for sending and receiving voice data.

DBB 1002 is also connected to display 1020 and sends information to it for interaction with a user of cell phone 1000 during a call process. Display 1020 may also display pictures received from the cellular network, from a local camera 1026, or from other sources such as USB 1026.

DBB 1002 may also send a video stream to display 1020 that is received from various sources such as the cellular network via RF transceiver 1006 or camera 1026. DBB 1002 may also send a video stream to an external video display unit via encoder 1022 over composite output terminal 1024. Encoder 1022 provides encoding according to PAL/SECAM/NTSC video standards.

In another embodiment, a resource tree as described above is stored in the embedded memory of DBB 1002. During operation, NodeB sends a command to the UE specifying a particular vertex. DBB 1002 then examines the stored resource tree and selects a sub-channel to use for transmission that corresponds to the specified vertex.

As used herein, the terms “applied,” “connected,” and “connection” mean electrically connected, including where additional elements may be in the electrical connection path. “Associated” means a controlling relationship, such as a memory resource that is controlled by an associated port. The terms assert, assertion, de-assert, de-assertion, negate and negation are used to avoid confusion when dealing with a mixture of active high and active low signals. Assert and assertion are used to indicate that a signal is rendered active, or logically true. De-assert, de-assertion, negate, and negation are used to indicate that a signal is rendered inactive, or logically false.

While the invention has been described with reference to illustrative embodiments, this description is not intended to be construed in a limiting sense. Various other embodiments of the invention will be apparent to persons skilled in the art upon reference to this description. This invention applies to all scheduled communication systems which perform channel sounding across multiple resource blocks. This invention applies in uplink and downlink.

Embodiments of this invention apply to any flavor of frequency division multiplex based transmission which is used to multiplex transmissions in an equi-spaced manner. Thus, the concept of valid specification of sub-channels can easily be applied to: OFDMA, OFDM, DFT-spread OFDM, DFT-spread OFDMA, SC-OFDM, SC-OFDMA, MC-CDMA, and all other FDM-based transmission strategies.

A Node B is generally a fixed station and may also be called a base transceiver system (BTS), an access point, or some other terminology. A UE, also commonly referred to as terminal or mobile station, may be fixed or mobile and may be a wireless device, a cellular phone, a personal digital assistant (PDA), a wireless modem card, and so on.

It is therefore contemplated that the appended claims will cover any such modifications of the embodiments as fall within the true scope and spirit of the invention.

What is claimed is:

1. A method for selecting a valid set of sub-channels {1, 2, . . . , K} for transmission between a user device and a base station, where each sub-channel “k” has sub-carrier spacing s[k], comprising:
defining a set A of possible tone spacing's being a sequence such that
$$Λ = \{ {M}_{1} , {M}_{1} {M}_{2} , {M}_{1} {M}_{2} {M}_{3} , … , {\prod }_{n = 1}^{N} {M}_{n} \} ,$$
where {M₁, M₂, . . . , M_{N}} are a sequence of positive integers; and
selecting a first valid set of sub-channels from the set of possible tone spacing's such that
$${\sum }_{k = 1}^{K} \frac{1}{s [ k ]} \leq 1$$
and wherein at least two s[k] have different integer values.

2. The method of claim 1, further comprising forming a resource tree having a root vertex with N sub-levels of vertices, wherein each vertex represents a potential sub-channel which is defined by the Mₙ tone spacing's and by a relative offset “m,” with respect to a frame of reference, such that any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}; and
wherein selecting a first valid set of sub-channels further comprises selecting sub-channels {1, 2, . . . , K}, each of which can be mapped onto a vertex of the resource tree such that no selected sub-channel descends from another selected sub-channel.

3. The method of claim 2, wherein selecting a first valid set of sub-channels further comprises selecting sub-channels using a greedy algorithm.

4. The method of claim 2, further comprising:
selecting at least a second valid set of sub-channels each of which can be mapped onto a vertex of the resource tree such that no selected sub-channel descends from another selected sub-channel; and
hopping between the first valid set of sub-channels and the at least second valid set of sub-channels while transmitting from the user device.

5. The method of claim 1 where more than one user device uses a same sub-channel.

6. The method of claim 1 where the user device transmits using any type of FDM-based modulation which uses sub-carriers.

7. The method of claim 1 where the transmission from the user device comprises a plurality of signal multiplexing blocks, and wherein another valid set of sub-channels are selected for each signal multiplexing block individually.

8. The method of claim 1 where each sub-channel is partitioned into a number of different sub-sub-channels each of which contains tones which are in a pre-defined range.

9. The method of claim 1, further comprising:
estimating a delay spread of transmissions received at the base station from the user device; and
limiting the set of possible tone spacing's for the user device reference signal such that a maximum tone spacing is less than or equal to a time duration of a reference signal from the user device divided by the estimated delay spread of transmissions received at the base station from the user device.

10. A NodeB for use in a cellular network system, comprising:
means for defining a set A of possible tone spacing's for defining a valid set of sub-channels {1, 2, . . . , K} for transmission between a user device and a base station, where each sub-channel “k” has sub-carrier spacing s[k], the possible tone spacing's being a sequence such that
$$Λ = \{ {M}_{1} , {M}_{1} {M}_{2} , {M}_{1} {M}_{2} {M}_{3} , … , {\prod }_{n = 1}^{N} {M}_{n} \} ,$$
where {M₁, M₂, . . . , M_{N}} are a sequence of positive integers; and
means for selecting a first valid set of sub-channels from the set of possible tone spacing's such that
$${\sum }_{k = 1}^{K} \frac{1}{s [ k ]} \leq 1$$
and wherein at least two s[k] have different integer values.

11. The NodeB of claim 10, further comprising:
means for forming a resource tree having a root vertex with N sub-levels of vertices, wherein each vertex represents a potential sub-channel which is defined by the Mₙ tone spacing's and by a relative offset “m,” with respect to a frame of reference, such that any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}; and
wherein the means for selecting a first valid set of sub-channels further comprises selecting sub-channels {1, 2, . . . , K}, each of which can be mapped onto a vertex of the resource tree such that no selected sub-channel descends from another selected sub-channel.

12. A user equipment (UE) for operation in a cellular network, comprising:
transmitter circuitry operable to transmit data on a selected sub-channel;
receiving circuitry operable to receive a command from a NodeB that directs use of a particular sub-channel that is selected from a valid set of sub-channels; and
processing circuitry connected to the transmitter circuitry and to the receiver circuitry operable to interpret the command form the NodeB and to configure the transmitter in accordance with the command.

13. The UE of claim 12 further comprising:
memory circuitry that stores a resource tree, wherein the resource tree has a root vertex with N sub-levels of vertices, wherein each vertex represents a potential sub-channel which is defined by Mₙ tone spacing's and by a relative offset “m,” with respect to a frame of reference, such that any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}, where {M₁, M₂, . . . , M_{N}} are a sequence of positive integers; and
wherein the received command specifies a particular vertex and the processing circuitry is operable to select a sub-channel for transmission by selecting a sub-channel that corresponds to the specified particular vertex.

14. A method for selecting a valid set of sub-channels {1, 2, . . . , K} for transmission between a user device and a base station, where each sub-channel “k” has sub-carrier spacing s[k], comprising:
defining a set A of possible tone spacing's being a sequence such that
$$Λ = \{ {M}_{1} , {M}_{1} {M}_{2} , {M}_{1} {M}_{2} {M}_{3} , … , {\prod }_{n = 1}^{N} {M}_{n} \} ,$$
where {M₁, M₂, . . . , M_{N}} are a sequence of positive integers;
forming a resource tree having a root vertex with N sub-levels of vertices, wherein each vertex represents a potential sub-channel which is defined by the Mₙ tone spacing's and by a relative offset “m,” with respect to a frame of reference, such that any vertex v[m, M₁M₂ . . . Mₙ] will have Mₙ₊₁ children v[m+qM₁M₂ . . . Mₙ, M₁M₂ . . . MₙMₙ₊₁], where q={0, 1, 2, . . . , Mₙ₊₁−1}; and
selecting a valid set of sub-channels {1, 2, . . . , K}, each of which can be mapped onto a vertex of the resource tree such that no selected sub-channel descends from another selected sub-channel.

15. The method of claim 14, wherein the selected valid set of sub-channels from the set of possible tone spacing's are such that
$${\sum }_{k = 1}^{K} \frac{1}{s [ k ]} \leq 1$$
and wherein at least two s[k] have different integer values.

16. The method of claim 14, further comprising:
estimating a delay spread of transmissions received at the base station from the user device; and
limiting the set of possible tone spacing's for the user device reference signal such that a maximum tone spacing is less than or equal to a time duration of a reference signal from the user device divided by the estimated delay spread of transmissions received at the base station from the user device.
